(19) United States
(12) Patent Application Publication
(10) Pub. No.: US 2016/0145544 A1
(43) Pub. Date: May 26, 2016

(54) CLEANING POUCH

(71) Applicant: The Procter & Gamble Company, Cincinnati, OH (US)

(72) Inventors: Nathalie Sophie LETZELTER, Newcastle upon Tyne (GB); Frank HULSKOTTER, Schwalbach am Taunus (DE); Rohan Govind MURKUNDE, Northumberland (GB); Kevin George GOODALL, Strombeek-Bever (BE); Marta REINOSO-GARCIA, Ludwigshafen (DE); Dieter Hannu BOECKH, Ludwigshafen (DE); Markus BIEL, Ludwigshafen (DE)

(21) Appl. No.: 14/945,459

(22) Filed: Nov. 19, 2015

(30) Foreign Application Priority Data
Nov. 26, 2014 (EP) 14194871.1

(51) Int. Cl. C11D 17/04; C11D 3/20; C11D 3/37; C11D 3/33

(52) U.S. Cl. CPC C11D 17/043; C11D 17/045; C11D 3/33; C11D 3/2075; C11D 3/3753

(57) ABSTRACT

A single or multi-compartment water-soluble cleaning pouch comprising a cleaning composition and an enveloping material, the pouch comprising at least one compartment comprising a liquid composition said liquid composition comprising a mixture of a complexing agent and an eRH reducing agent wherein the complexing agent is selected from the group consisting of methyl glycine diacetic acid, its salts and mixtures thereof and the eRH reducing agent is a salt of an organic acid selected from the group consisting of mono-, di-carboxylic acids and mixtures thereof.

### TECHNICAL FIELD

The present invention is in the field of cleaning. It relates to a cleaning product, in particular a cleaning product in the form of a water-soluble pouch, more in particular the pouch comprises a liquid composition comprising a mixture of a complexing agent and a salt of an organic acid acting as eRH agent for the complexing agent.

### BACKGROUND OF THE INVENTION

Unit-dose detergents have become widely spread lately. As the name indicates, unit-dose detergents are pouches containing a single dose of detergent. A common form of unit-dose detergent nowadays corresponds to detergent compositions enclosed by a water-soluble enveloping material. This obviates the need to unwrap. The formulation of detergents to be enclosed by water-soluble material continues to be a challenge. This is most so in cases in which phosphate needs to be replaced. Phosphate is not only an excellent cleaning active but also contributes to processability and product stability by adsorbing moisture from the surrounding environment and/or from the product itself.

Aminocarboxylate complexing agents can be used to replace phosphate in its cleaning capacity. Methyl glycine diacetic acid (MGDA), in particular, is a very good complexing agent, however, it is not easy to formulate with due to its hygroscopicity. Aminocarboxylate complexing agents are usually synthesized in liquid form. They can be further processed into solid particles or granules.

In some instances it is desirable to use aminocarboxylate complexing agents in liquid form that is how they are synthesized. When aminocarboxylate complexing agents are synthesized in liquid form, they have a high level of solvent, usually water, associated to them. This makes their use inconvenient in terms of transport (high volume of the liquid is needed in order to get not too high level of active). This high level of solvent can also be a problem when the complexing agent needs to be formulated as part of a detergent in unit dose from because the space is limited. In addition to the space constraints, in the case of unit dose detergents, the solvent can also bring incompatibility issues with the rest of the active ingredients of the detergent composition and can also present negative interactions with the water-soluble enveloping material.

Other considerations when designing a liquid composition is the viscosity of the liquid. Liquids to be packed in water-soluble films to form a pouch should not be too thin otherwise they will splash while being dosed into the pouch negatively impacting on the seal. Thick liquids require more powerful pumps or would increase the duration of the filling step during manufacture thereby increasing the processing time.

The objective of the invention is to provide a water-soluble cleaning pouch containing a liquid composition comprising MGDA.

### SUMMARY OF THE INVENTION

The present invention provides a water-soluble cleaning pouch, i.e. a pouch containing a cleaning composition. The pouch can have a single or a plurality of compartments. At least one compartment comprises a liquid composition, the liquid composition comprises a mixture. The mixture consists of a complexing agent and an eRH reducing agent. The complexing agent, sometimes herein is referred to as “first complexing agent”, is selected from the group consisting of methyl glycine diacetic acid (MGDA), its salts and mixtures thereof. Preferably, the complexing agent is the trisodium salt of MGDA.

For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 5, preferably at least 6. The stability constant, log K, is measured in a solution of ionic strength of 0.1, at a temperature of 25° C.

The eRH reducing agent is a salt of an organic acid, preferably an alkali metal salt. The organic acid is selected from the group consisting of mono-, di-carboxylic acids and mixtures thereof. Preferably, the salts have potassium as cation. Potassium formate has been found the most efficient salt in terms of eRH reduction. As its name indicated, the eRH reducing agent reduces the equilibrium relative humidity of a liquid composition comprising the complexing agent.

The mixture comprises at least about 50% by weight thereof of the complexing agent, preferably from 50% to 97%, more preferably from 60% to 90% by weight of the mixture. The resulting liquid composition comprising the mixture presents reduced eRH.

The liquid composition has an equilibrium relative humidity (eRH) of about 65% or less, preferably about 20% or more and about 60% or less, more preferably about 30% or more and about 55% or less at 20° C. as measured as detailed herein below. A low relative humidity is essential for detergent compositions comprising moisture sensitive ingredients such as bleach, enzymes, etc otherwise incompatibility issues might arise. Incompatibilities can occur when the moisture sensitive ingredients are in the compartment containing the liquid composition or in a separate compartment, due to moisture migration through the enveloping material. The low eRH of the liquid composition also helps to preserve the physical and mechanical properties of the enveloping material and avoids premature dissolution and weakening of the enveloping material.

Preferably the liquid composition of the pouch of the invention is aqueous, by aqueous is herein meant that the liquid composition comprises about 10% or more, preferably about 15% or more, more preferably about 20% or more and especially about 30% or more and about 60% or less of water by weight of the liquid composition.

Liquid compositions comprising a high level of the complexing agent contribute to good cleaning due to the good chelating properties of the complexing agent.

For the purpose of the present invention the term “aminocarboxylic” refers to aminocarboxylic acids and salts thereof. Preferably the aminocarboxylic acid is at least partially neutralized or totally neutralized with alkali metals. By “partially neutralized” is herein meant that an average of at least 50%, preferably at least 70% and more preferably at least 90% of the COOH groups per molecule of the aminocarboxylic acid are neutralized with an alkali metal, preferably sodium, potassium or mixtures thereof. Sodium is the especially preferred alkali metal.

Liquid compositions comprising high level of the first complexing agent present very good chelating properties but on the other hand compositions comprising high level of the first complexing agent can be instable, the first complexing agent might crystallize and/or precipitate especially when the eRH of the liquid composition is reduced below 60%. The stability of the liquid composition can be improved by adding to the liquid composition a stabilizer of the first complexing agent. Polyamines in which the hydrogen atoms of the amines have been partially or fully substituted by —CH2COOH groups and the —CH2COOH groups are partially or fully neutralized with alkali metal cations have been found to be good stabilizers.

The stability of the first complexing agent can be improved by adding a second complexing agent (that is different to the first complexing agent) to the liquid composition, in particular an aminocarboxylic complexing agent. More in particular, the second aminocarboxylic complexing agent is selected from the group consisting of glutamic acid diacetic acid (GLDA), its salts and mixtures thereof. Preferably the salt is formed with an alkali metal, more preferably selected from the group consisting of sodium, potassium and mixtures thereof. Glutamic acid diacetic acid, its salts and mixtures thereof have been found to greatly improve the stability of liquid compositions comprising high level of the first complexing agent and at the same time contribute to the cleaning. Preferred for use herein is the sodium salt of GLDA.

Preferably, the complexing agent and the eRH reducing agent are in a weight ratio of at least 2:1, more preferably from 2:1 to 10:1.

Liquid compositions having a pH of from about 10 to about 11, preferably from 10.5 to 11 as measured as a 1% aqueous solution at 22° C. have been found to have good compatibility with the enveloping material in particular when the enveloping material is a polyvinyl alcohol film. Compositions outside of this pH range can lead to the formation of residues on the outer surface of the film, making the film opaque or the composition can weep through the film, depending on the conditions of the surrounding environment.

In some instances it is desirable to have liquid compositions with low viscosity. Low viscosity liquid compositions can be delivered into the pouch at higher speed than liquid compositions of higher viscosity. Preferred viscosities for the composition of the invention are in the range of from about 200 to about 800, more preferably from about 350 to about 550 mPa s determined according to DIN 53018-1:2008-09 at 23° C.

A preferred pouch herein comprises a compartment containing a liquid composition said liquid composition comprising:
from about 10 to about 50% by weight thereof of the complexing agent,
from about 10 to about 50% by weight thereof of the second complexing agent,
from about 5 to about 30% by weight thereof of a salt of formic acid, acetic acid or a mixture thereof,
from 0 to about 5% by weight thereof of a polyamine in which the hydrogen atoms of the amines have been partially or fully substituted by —CH2COOH groups and the —CH2COOH groups are partially or fully neutralized with alkali metal cations.

Another preferred pouch herein comprises a compartment containing a liquid composition said composition comprising:
from about 10 to about 40% by weight thereof of the complexing agent,
from about 10 to about 40% by weight thereof of the second complexing agent,
from about 5 to about 20% by weight thereof of a salt of formic acid, acetic acid or a mixture thereof,
from 0 to about 5% by weight thereof of a polyamine in which the hydrogen atoms of the amines have been partially or fully substituted by —CH2COOH groups and the —CH2COOH groups are partially or fully neutralized with alkali metal cations.

Another preferred pouch herein comprises a compartment containing a liquid composition said liquid composition comprising:
from about 10 to about 40% by weight thereof of the complexing agent wherein the complexing agent is a salt of MGDA, preferably the sodium salt
from about 10 to about 40% by weight thereof of the second complexing agent wherein the second complexing agent is a salt of GLDA, preferably the sodium salt
from about 5 to about 20% by weight thereof of a salt of formic acid, acetic acid or a mixture thereof, preferably potassium formate from 0 to about 5% by weight thereof of a polyamine in which the hydrogen atoms of the amines have been partially or fully substituted by —CH2COOH groups and the —CH2COOH groups are partially or fully neutralized with alkali metal cations.

It has been found that the stability of the pouch is improved when the enveloping material comprises polyvinyl alcohol and a plasticiser and the liquid composition preferably comprises the same plasticiser as the film.

A preferred pouch herein is a multi-compartment pouch comprising a second compartment containing a second composition comprising a moisture sensitive ingredient wherein the moisture sensitive ingredient is preferably selected from the group consisting of bleach, enzymes and mixtures thereof. The stability properties of the liquid composition of the invention contribute to the total stability of the pouch.

### DETAILED DESCRIPTION OF THE INVENTION

The present invention envisages a water-soluble cleaning pouch comprising at least one compartment comprising a liquid composition said liquid composition comprising a mixture. The mixture consists of a complexing agent and an eRH reducing agent. The pouch provides very good cleaning and at the same time presents good stability.

### Water-Soluble-Pouch

A water-soluble cleaning pouch is a pouch containing a cleaning composition, preferably an automatic dishwashing or laundry detergent composition, and an enveloping material. The enveloping material is water-soluble and preferably a water-soluble film. Both the cleaning composition and the enveloping material are water-soluble. They readily dissolve when exposed to water in an automatic dishwashing or laundry process, preferably during the main wash. The pouch can have a single compartment or a plurality of compartments (multi-compartment pouch). One of the compartments of the pouch comprises a liquid composition, this liquid composition can be part or the total cleaning composition. In the case of multi-compartment pouches, the liquid composition would be a part of the total cleaning composition.

By “multi-compartment pouch” is herein meant a pouch having at least two compartments, preferably at least three compartments, each compartment contains a composition surrounded by enveloping material. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit, pouch aging optimisation and enveloping material reduction are multi-compartment pouches having some superposed compartments and some side-by-side compartments.

### Enveloping Material

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns.

50 grams+−0.1 gram of enveloping material is added in a pre-weighed 400 ml beaker and 245 ml+−1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble polyvinyl alcohol film.

The pouch can, for example, be obtained by injection moulding or by creating compartments using a film. The enveloping material is usually moisture permeable. The pouch of the invention is stable even when the enveloping material is moisture permeable. The liquid composition confers stability to the pouch, in terms of both interaction among the different compositions and interaction with the surrounding environment.

Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Kuraray, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, dipropylene glycol, sorbitol and mixtures thereof. Preferably the enveloping material comprises glycerol as plasticisers. Other useful additives include disintegrating aids.

### Liquid Composition

The liquid composition has an eRH of about 65% or less, preferably about 20% or more and about 60% or less, more preferably about 30% or more and about 55% or at 20° C. as measured as detailed herein below. The pouch presents a good stability profile (including chemical stability of the cleaning composition and physical and mechanical stabilities of the enveloping material) and at the same time provides good cleaning.

Equilibrium relative humidity “eRH” measures the vapour pressure generated by the moisture present in a composition. It can be expressed as:

eRH=100×Aw

Wherein Aw is water activity:

Aw=p/ps, where:

p: partial pressure of water vapour at the surface of the composition.

ps: saturation pressure, or the partial pressure of water vapour above pure water at the composition temperature.

Water activity reflects the active part of moisture content or the part which, under the established conditions (20° C.), can be exchanged between a composition and its environment. For the purpose of this invention all the measurements are taken at atmospheric pressure unless stated otherwise.

The eRH of the liquid composition can be measured using any commercially available equipment, such as a water activity meter (Rotronic A2101).

The cleaning composition is preferably an automatic dishwashing composition. The composition is preferably phosphate free.

Preferably, the liquid composition is aqueous and comprises about 10% or more, preferably about 15% or more, more preferably about 20% or more of water by weight of the liquid composition. Preferably the liquid composition comprises about 70% or less, more preferably about 50% or less of water by weight of the liquid composition.

Preferably, the liquid composition comprises at least about 20%, preferably at least about 30% and especially at least 40% of the complexing agent by weight of the liquid composition. Compositions with such a high level of complexing mixtures are very good in terms of cleaning.

### Complexing Agent

The complexing agent is selected from the group consisting of methyl glycine diacetic acid (MGDA), its salts and mixtures thereof. In particular, the first complexing agent is selected from lithium salts, potassium salts and preferably sodium salts of methylglycine diacetic acid. The first complexing agent can be partially or preferably fully neutralized with the respective alkali metal. Preferably an average of from 2.7 to 3 COOH groups per molecule of MGDA is neutralized with alkali metal, preferably with sodium. Preferably, the first complexing agent is the trisodium salt of MGDA. The sodium salt of methyl glycine diacetic acid has a high Ca and Mg binding capacity, that in automatic dishwashing contributes to reducing filming and spotting, contributing to cleaning by breaking up soils bridged by calcium and provide anti-scaling benefits. The first complexing agent has good environmental profile.

The first complexing agent can be selected from racemic mixtures of alkali metal salts of MGDA and of the pure enantiomers such as alkali metal salts of L-MGDA, alkali metal salts of D-MGDA and of mixtures of enantiomerically enriched isomers.

Minor amounts of the first complexing agent may bear a cation other than alkali metal. It is thus possible that minor amounts, such as 0.01 to 5 mol-% of the first complexing agent bear alkali earth metal cations such as Mg2+ or Ca2+, or an Fe+2 or Fe+3 cation.

The level of the first complexing agent in the cleaning composition is preferably from about 5 to about 30%, more preferably from about 10% to about 20% by weight of the cleaning composition.

The level of the first complexing agent in the liquid composition is preferably from about 10% to about 40%, more preferably from about 10% to about less than 30% by weight of the liquid composition. Liquid compositions comprising more than 30% of the first complexing agent by weight of the composition can be difficult to stabilize.

### eRH Reducing Agent

The salt of the organic acid would contribute to the reduction of the eRH of the liquid composition as compared to a liquid composition free of salt.

Liquid compositions comprising the mixture of complexing agent and an eRH reducing agent can present a very good rheological profile. Preferably such compositions have a viscosity in the range of from about 100 to about 800, more preferably from about 200 to about 500 mPa·s, determined according to DIN 53018-1:2008-09 at 23° C. These compositions are very convenient from a processing viewpoint and also from a dissolution viewpoint.

Preferred for use herein have been found to be salts of organic acids, preferably salts of mono- and di-carboxylic acids, more preferably salts of mono-carboxylic acids. Preferred herein are metal salts, in particular alkali metal salts and even more preferably salts of potassium.

Specially preferred salts for use herein are selected from salts of formic acid, acetic acid and mixtures thereof even more preferably a sodium or potassium salt. Potassium formate has been found to be the preferred eRH reducing agent for use herein.

The level of salt, preferably alkali metal salt of the organic acid in the liquid composition is preferably from about 0.2% to about 20%, more preferably from about 5% to about 15% by weight of the liquid composition.

Preferably, the weight ratio of the first complexing agent to the salt of the organic acid is at least about 2:1, more preferably at least about 3:1.

### Polyamine

Liquid compositions according to the invention may further comprise a polyamine which acts as stabilizer for the first complexing agent. Preferably, the liquid composition comprises from about 0 to about 5%, more preferably from about 0.1 to about 4% and especially from about 0.1 to about 3% by weight of the liquid composition of a stabilizer for the first complexing agent. Preferably the first complexing agent and the stabilizer are in a weight ratio of at least about 10 to 1, more preferably at least about 15 to 1 and especially at least about 20 to 1.

Suitable polyamines include polyamines in which the hydrogen atoms of the amines have been partially or fully substituted by —CH2COOH groups, the —CH2COOH groups being partially or fully neutralized with alkali metal cations.

The term “polyamine” herein refers to polymers and copolymers that contain at least one amine per repeating unit. An amine is a compound formally derived from ammonia by replacing one, two, or three of its hydrogen atoms by hydrocarbyl groups, and having the general structures R—NH2 (primary amines), R2NH (secondary amines), R3N (tertiary amines). In the polyamines of the composition of the invention, the hydrogen atoms of the original amine have been fully or partially substituted by —CH2COOH groups.

Tertiary amino groups can be preferred. The basic polyamine is converted to carboxymethyl derivatives, and the hydrogen atoms are fully substituted or preferably partially, for example 50 to 95 mol %, preferably 70 to 90 mol %, substituted with CH2COOH groups, the CH2COOH groups are partially or fully neutralized with alkali metal cations. In the context of the present invention, such polymers in which more than 95 mol % to 100 mol % of the hydrogen atoms are substituted with CH2COOH groups will be considered to be fully substituted with CH2COOH groups. NH2 groups from, e. g., polyvinylamines or polyalkylenimines can be substituted with one or two CH2COOH group(s) per N atom, preferably with two CH2COOH groups per N atom.

The numbers of CH2COOH groups in the polyamine divided by the potential total number of CH2COOH groups, assuming one CH2COOH group per NH group and two CH2COOH groups per NH2 group, will also be termed as “degree of substitution” in the context of the present invention.

The degree of substitution can be determined, for example, by determining the amine numbers (amine values) of the polymer and its respective polyamine before conversion to the CH2COOH-substituted polymer, preferably according to ASTM D2074-07.

Examples of polyamines are polyvinylamine, polyalkylenepolyamine and in particular polyalkylenimines such as polypropylenimines and polyethylenimine.

Within the context of the present invention, polyalkylenepolyamines are preferably understood as meaning those polymers which comprise at least 6 nitrogen atoms and at least five C2-C10-alkylene units, preferably C2-C3-alkylene units, per molecule, for example pentaethylen-hexamine, and in particular polyethylenimines with 6 to 30 ethylene units per molecule. Within the context of the present invention, polyalkylenepolyamines are to be understood as meaning those polymeric materials which are obtained by homo- or copolymerization of one or more cyclic imines, or by grafting a (co)polymer with at least one cyclic imine Examples are polyvinylamines grafted with ethylenimine and polyimidoamines grafted with ethylenimine.

Preferred polyamines are polyalkylenimines such as polyethylenimines and polypropylenimines, polyethylenimines being preferred. Polyalkylenimines such as polyethylenimines and polypropylenimines can be linear, essentially linear or branched.

Specially preferred polyethylenimines are selected from highly branched polyethylenimines Highly branched polyethylenimines are characterized by their high degree of branching (DB).

The degree of branching can be determined, for example, by 13C-NMR spectroscopy, preferably in D20, and is defined as follows:

DB=D+T/D+T+L

with D (dendritic) corresponding to the fraction of tertiary amino groups, L (linear) corresponding to the fraction of secondary amino groups and T (terminal) corresponding to the fraction of pri-mary amino groups.

Within the context of the present invention, highly branched polyethylenimines are polyethylenimines with DB in the range from 0.25 to 0.90.

A preferred polyethylenimine is selected from highly branched polyethylenimines (homopolymers) with an average molecular weight Mw in the range from 600 to 75 000 g/mol, preferably in the range from 800 to 25 000 g/m

Other preferred polyethylenimines are selected from copolymers of ethylenimine, such as copolymers of ethylenimine with at least one diamine with two NH2 groups per molecule other than ethylenimine, for example propylene imine, or with at least one compound with three NH2 groups per molecule such as melamine.

Alternatively, the stabilizer is selected from branched polyethylene-imines, partially or fully substituted with CH2COOH groups, partially or fully neutralized with Na+.

Within the context of the present invention, the stabilizer is preferably used in covalently modified form, and specifically such that in total up to at most 100 mol %, preferably in total 50 to 98 mol %, of the nitrogen atoms of the primary and secondary amino groups of the polymer—percentages being based on total N atoms of the primary and secondary amino groups in polymer—have been reacted with at least one carboxylic acid such as, e. g., Cl—CH2COOH, or at least one equivalent of hydrocyanic acid (or a salt thereof) and one equivalent of formaldehyde. Within the context of the present application, said reaction (modification) can thus be, for example, an alkylation. Most preferably, up to at most 100 mol %, preferably in total 50 to 99 mol %, of the nitrogen atoms of the primary and secondary amino groups of the polymer have been reacted with formaldehyde and hydrocyanic acid (or a salt thereof), for example by way of a Strecker synthesis. Tertiary nitrogen atoms of polyalkylenimine that may form the basis of the stabilizer are generally not bearing a CH2COOH group.

The polyamine can, for example, have an average molecular weight (Mn) of at least 500 g/mol; preferably, the average molecular weight of the polyamine is in the range from 500 to 1,000,000 g/mol, particularly preferably 800 to 50,000 g/mol, determined determination of the amine numbers (amine values), for example according to ASTM D2074-07, of the respective polyamine before alkylation and after and calculation of the respective number of CH2COOH groups. The molecular weight refers to the respective per-sodium salt.

In aqueous solutions according to the invention, the CH2COOH groups of the polyamine are partially or fully neutralized with alkali metal cations. The non-neutralized groups COOH can be, for example, the free acid. It is preferred that 90 to 100 mol % of the CH2COOH groups of the polyamine are in neutralized form.

It is preferred that the neutralized CH2COOH groups of the polyamine are neutralized with the same alkali metal as the complexing agents.

CH2COOH groups of the polyamine may be neutralized, partially or fully, with any type of alkali metal cations, preferably with K+ and particularly preferably with Na+.

Suitable polyamines for use herein include Triton P as supplied by BASF.

### Second Complexing Agent

The liquid composition can comprise a second complexing agent. Liquid compositions comprising a first and a second complexing agents have good solubility and eRH. Without being bound by theory, it is believed that the second complexing agent helps to avoid the crystallization of the first complexing agent in the liquid composition and might also contribute to eRH reduction of the liquid composition.

The second complexing agent also contributes to cleaning.

The second complexing agent is different from the first complexing agent. It is preferably an aminocarboxylic complexing agent, more preferably selected from the group consisting of glutamic acid diacetic acid (GLDA), its salts and mixtures thereof. In particular, the second complexing agent is selected from lithium salts, potassium salts and preferably sodium salts of glutamic acid diacetic acid. The second complexing agent can be fully or preferably partially neutralized with the respective alkali. Preferably, an average of from 3.5 to 4 COOH groups per molecule of GLDA is neutralized with alkali metal, preferably with sodium. More preferably, an average of from 3.5 to 3.8 COOH groups per molecule of GLDA is neutralized with sodium.

Minor amounts of the second complexing agent may bear a cation other than alkali metal. It is thus possible that minor amounts, such as 0.01 to 5 mol-% of the second complexing agent bear alkali earth metal cations such as Mg2+ or Ca2+, or an Fe+2 or Fe+3 cation.

The second complexing agent can be selected from racemic mixtures of alkali metal salts of GLDA and of the pure enantiomers such as alkali metal salts of L-GLDA, alkali metal salts of D-GLDA and of mixtures of enantiomerically enriched isomers. Preferably, the second complexing agent is essentially L-glutamic acid (L-GLDA) that is at least partially neutralized with alkali metal. “Essentially L-glutamic acid” shall mean that the second complexing agent contains more than 95% by weight of L-GLDA and less than 5% by weight D-GLDA, each at least partially neutralized with alkali metal.

Preferably, the second complexing agent does not contain detectable amounts of D-GLDA. The analysis of the enantiomers can be performed by measuring the polarization of light (polarimetry) or preferably by chromatography, for example by HPLC with a chiral column.

If present, the level of the second complexing agent in the cleaning composition is preferably from about 5 to about 40%, more preferably from about 10% to about 30% by weight of the cleaning composition.

If present, the level of the second complexing agent in the liquid composition is preferably from about 10% to about 40%, more preferably from about 15% to about 30% by weight of the liquid composition.

Liquid compositions comprising the first and second complexing agents can have a range of viscosities. Aqueous solutions of the first complexing agent have low viscosity. In many operations a higher viscosity is desirable, e. g., in order to avoid splashing of such solutions during processing. On the other hand, highly concentrated aqueous solutions of the second complexing agent at ambient temperature can have high viscosity. Compositions comprising the first and second complexing agents can be designed to have a predetermined viscosity.

### Cleaning Composition

As described herein above the cleaning composition can be formed by partial compositions or each of the compositions of the pouch can be a fully formulated cleaning compositions. In addition to the liquid composition comprising the mixture of the complexing agent and the eRH reducing agent, the pouch preferably comprises a second composition comprising bleach and enzymes, the second composition is preferably in solid form.

Preferably, the cleaning composition of the invention is phosphate free. By “phosphate free” herein is meant that the composition comprises less than 1% by weight thereof of phosphate.

The following actives can be used in the pouch of the invention, in any of the compositions.

### Bleach System

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate is the preferred bleach for use herein. The percarbonate is most preferably incorporated into the products in a coated form which contributes to product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 1 to about 20%, more preferably from about 2 to about 15%, even more preferably from about 3 to about 12% and especially from about 4 to about 10% by weight of the composition. Preferably the second composition comprises bleach.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators if included in the compositions of the invention are in a level of from about 0.01 to about 10%, preferably from about 0.1 to about 5% and more preferably from about 1 to about 4% by weight of the total composition. If the composition comprises bleach activator then the bleach activator is preferentially placed in the second composition.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include the manganese triazacyclononane and related complexes (U.S. Pat. No. 4,246,612, U.S. Pat. No. 5,227,084); Co, Cu, Mn and Fe bipyridylamine and related complexes (U.S. Pat. No. 5,114,611); and pentamine acetate cobalt(III) and related complexes (U.S. Pat. No. 4,810,410). A complete description of bleach catalysts suitable for use herein can be found in WO 99/06521, pages 34, line 26 to page 40, line 16.

Manganese bleach catalysts are preferred for use in the composition of the invention. Especially preferred catalyst for use here is a dinuclear manganese-complex having the general formula:

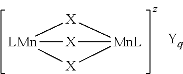

wherein Mn is manganese which can individually be in the III or IV oxidation state; each x represents a coordinating or bridging species selected from the group consisting of H2O, O22-, O2-, OH—, HO2-, SH—, S2-, >SO, Cl—, N3-, SCN—, RCOO—, NH2- and NR3, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=z/[charge Y].

Preferred manganese-complexes are those wherein x is either CH₃COO⁻ or O² or mixtures thereof, most preferably wherein the manganese is in the IV oxidation state and x is O²⁻. Preferred ligands are those which coordinate via three nitrogen atoms to one of the manganese centres, preferably being of a macrocyclic nature. Particularly preferred ligands are:

(1) 1,4,7-trimethyl-1,4,7-triazacyclononane, (Me-TACN); and

(2) 1,2,4,7-tetramethyl-1,4,7-triazacyclononane, (Me-Me TACN).

The type of counter-ion Y for charge neutrality is not critical for the activity of the complex and can be selected from, for example, any of the following counter-ions: chloride; sulphate; nitrate; methylsulphate; surfactant anions, such as the long-chain alkylsulphates, alkylsulphonates, alkylbenzenesulphonates, tosylate, trifluoromethylsulphonate, perchlorate (ClO₄⁻), BPh₄⁻, and PF₆⁻′ though some counter-ions are more preferred than others for reasons of product property and safety.

Consequently, the preferred manganese complexes useable in the present invention are:

(I) [(Me-TACN)Mn^{IV}(Âμ-0)₃Mn^{IV}(Me-TACN)]²⁺(PF₆⁻)₂

(II) [(Me-MeTACN)Mn^{IV}(Âμ-0)₃Mn^{IV}(Me-MeTACN)]²⁺(PF₆)₂

(III) [(Me-TACN)Mn^{III}(Âμ-0)(Âμ-0Ac)₂Mn^{III}(Me-TACN)]²⁺(PF₆)₂

(IV) [(Me-MeTACN)Mn^{III}(Âμ-0)(Âμ-0Ac)₂Mn^{III}(Me-MeTACN)]²⁺(PF₆)₂

which hereinafter may also be abbreviated as:

(I) [Mn^{IV}₂(Âμ-0)₃(Me-TACN)₂](PF₆)₂

(II) [Mn^{IV}₂(Âμ-0)₃(Me-MeTACN)₂](PF₆)₂

(III) [Mn^{III}₂(Âμ-0) (Âμ-0Ac)₂(Me-TACN)₂](PF₆)₂

(IV) [Mn^{III}₂(Âμ-0) (Âμ-0Ac)₂(Me-TACN)₂](PF₆)₂

The structure of I is liven below:

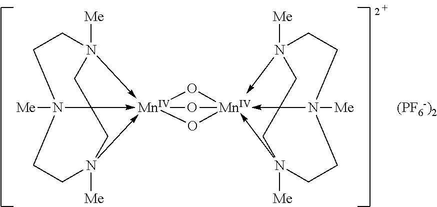

abbreviated as [Mn^{IV}₂(Âμ-0)₃(Me-TACN)₂](PF₆)₂.

The structure of II is given below:

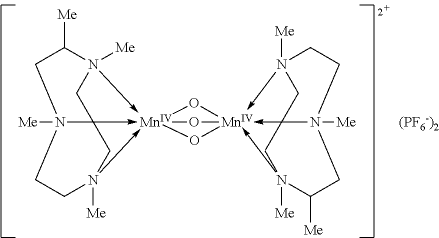

abbreviated as [Mn^{IV}₂(Âμ-0)₃(Me-MeTACN)₂](PF₆)₂.

It is of note that the manganese complexes are also disclosed in EP-A-0458397 and EP-A-0458398 as unusually effective bleach and oxidation catalysts. In the further description of this invention they will also be simply referred to as the “catalyst”.

Bleach catalyst are included in the compositions of the invention are in a preferred level of from about 0.001 to about 10%, preferably from about 0.05 to about 2% by weight of the total composition.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Surfactants may be present in amounts from 0 to 15% by weight, preferably from 0.1% to 10%, and most preferably from 0.25% to 8% by weight of the total composition.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, S130A, Y167A, R1705, A194P, V205I and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

(i) G118V+S128L+P129Q+S130A

(ii) S101M+G118V+S128L+P129Q+S130A

(iii) N76D+N87R+G118R+S128L+P129Q+S130A+S188D+N248R

(iv) N76D+N87R+G118R+S128L+P129Q+S130A+S188D+V244R

(v) N76D+N87R+G118R+S128L+P129Q+S130A

(vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the product of the invention include from about 0.1 to about 10, more preferably from about 0.5 to about 5 and especially from about 1 to about 4 mg of active protease per grams of product.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:

9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.

(b) variants exhibiting at least 95% identity with the wild-type enzyme from Bacillus sp.707 (SEQ ID NO:7 in U.S. Pat. No. 6,093,562), especially those comprising one or more of the following mutations M202, M208, S255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, and mixtures thereof.

### Cellulases

The product of the invention preferably comprises other enzymes in addition to the protease and/or amylase. Cellulase enzymes are preferred additional enzymes, particularly microbial-derived endoglucanases exhibiting endo-beta-1,4-glucanase activity (E.C. 3.2.1.4). Preferred commercially available cellulases for use herein are Celluzyme®, Celluclean®, Whitezyme® (Novozymes A/S) and Puradax HA® and Puradax® (Genencor International).

Preferably, the product of the invention comprises at least 0.01 mg of active amylase per gram of composition, preferably from about 0.05 to about 10, more preferably from about 0.1 to about 6, especially from about 0.2 to about 4 mg of amylase per gram of composition.

Preferably, the protease and/or amylase of the product of the invention are in the form of granulates, the granulates comprise less than 29% of efflorescent material by weight of the granulate or the efflorescent material and the active enzyme (protease and/or amylase) are in a weight ratio of less than 4:1.

### Polymer

The polymer, if present, is used in any suitable amount from about 0.1% to about 30%, preferably from 0.5% to about 20%, more preferably from 1% to 15% by weight of the composition. Sulfonated/carboxylated polymers are particularly suitable for the composition of the invention.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

As noted herein, the sulfonated/carboxylated polymers may comprise (a) at least one structural unit derived from at least one carboxylic acid monomer having the general formula (I):

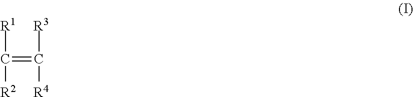

wherein R¹ to R⁴ are independently hydrogen, methyl, carboxylic acid group or CH₂COOH and wherein the carboxylic acid groups can be neutralized; (b) optionally, one or more structural units derived from at least one nonionic monomer having the general formula (II):

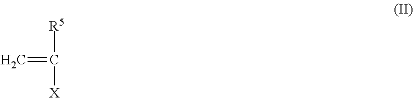

wherein R⁵ is hydrogen, C₁ to C₆ alkyl, or C₁ to C₆ hydroxyalkyl, and X is either aromatic (with R⁵ being hydrogen or methyl when X is aromatic) or X is of the general formula (III):

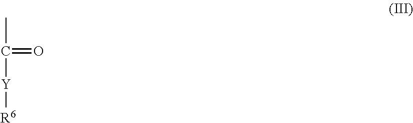

wherein R⁶ is (independently of R⁵) hydrogen, C₁ to C₆ alkyl, or C₁ to C₆ hydroxyalkyl, and Y is O or N; and at least one structural unit derived from at least one sulfonic acid monomer having the general formula (IV):

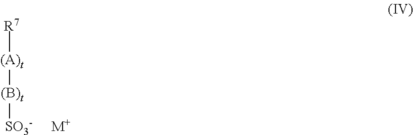

wherein R7 is a group comprising at least one sp2 bond, A is O, N, P, S or an amido or ester linkage, B is a mono- or polycyclic aromatic group or an aliphatic group, each t is independently 0 or 1, and M+ is a cation. In one aspect, R7 is a C2 to C6 alkene. In another aspect, R7 is ethene, butene or propene.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium(meth)allyl sulfonate, vinyl sulfonate, sodium phenyl(meth)allyl ether sulfonate, or 2-acrylamido-methyl propane sulfonic acid. Preferred non-ionic monomers include one or more of the following: methyl(meth)acrylate, ethyl(meth)acrylate, t-butyl(meth)acrylate, methyl(meth)acrylamide, ethyl(meth)acrylamide, t-butyl(meth)acrylamide, styrene, or α-methyl styrene.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

The carboxylic acid is preferably (meth)acrylic acid. The sulfonic acid monomer is preferably one of the following: 2-acrylamido methyl-1-propanesulfonic acid, 2-methacrylamido-2-methyl-1-propanesulfonic acid, 3-methacrylamido-2-hydroxypropanesulfonic acid, allysulfonic acid, methallysulfonic acid, allyloxybenzenesulfonic acid, methallyloxybenzensulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethylacrylamid, sulfomethylmethacrylamide, and water soluble salts thereof. The unsaturated sulfonic acid monomer is most preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Dow; Goodrich K-798, K-775 and K-797 supplied by BF Goodrich; and ACP 1042 supplied by ISP technologies Inc. Particularly preferred polymers are Acusol 587G and Acusol 588G supplied by Dow.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Other suitable polymer for use herein includes a polymer comprising an acrylic acid backbone and alkoxylated side chains, said polymer having a molecular weight of from about 2,000 to about 20,000, and said polymer having from about 20 wt % to about 50 wt % of an alkylene oxide. The polymer should have a molecular weight of from about 2,000 to about 20,000, or from about 3,000 to about 15,000, or from about 5,000 to about 13,000. The alkylene oxide (AO) component of the polymer is generally propylene oxide (PO) or ethylene oxide (EO) and generally comprises from about 20 wt % to about 50 wt %, or from about 30 wt % to about 45 wt %, or from about 30 wt % to about 40 wt % of the polymer. The alkoxylated side chains of the water soluble polymers may comprise from about 10 to about 55 AO units, or from about 20 to about 50 AO units, or from about 25 to 50 AO units. The polymers, preferably water soluble, may be configured as random, block, graft, or other known configurations. Methods for forming alkoxylated acrylic acid polymers are disclosed in U.S. Pat. No. 3,880,765.

Other suitable polymers for use herein include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethyl enedioxy)diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Other suitable builders are disclosed in WO 95/01416, to the contents of which express reference is hereby made.

Other suitable polymer for use herein includes polyaspartic acid (PAS) derivatives as described in WO 2009/095645 A1.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and specially from 0.3 to 3% by weight of the composition of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and especially from 0.3 to 3% by weight of the composition of a glass care agent, preferably the glass care agent is a zinc salt.

### Multi-Compartment Pouch

A multi-compartment pouch is formed by a plurality of water-soluble enveloping materials which form a plurality of compartments. The enveloping materials can have the same or different solubility profiles to allow controlled release of different ingredients. Preferably the enveloping material is a water-soluble polyvinyl alcohol film.

Preferred pouches comprise superposed compartments. This disposition contributes to the compactness, robustness and strength of the pouch, additionally, it minimise the amount of water-soluble material required. The robustness of the pouch allows also for the use of very thin films without compromising the physical integrity of the pouch. The pouch is also very easy to use because the compartments do not need to be folded to be used in machine dispensers of fix geometry. It is crucial in the case of multi-compartment pouches comprising liquid and solid compositions in different compartments that the liquid compositions have a low equilibrium relative humidity. The liquid composition of the pouch of the invention is extremely suitable for multi-compartment pouches comprising a solid composition.

Preferably, the second compartment contains a solid composition, more preferably in powder form. The solid and the liquid compositions are preferably in a weight ratio of from about 5:1 to about 1:5, more preferably from about 3:1 to about 1:2 and even more preferably from about 2:1 to about 1:1. This kind of pouch is very versatile because it can accommodate compositions having a broad spectrum of values of solid:liquid ratio.

For dispenser fit reasons, especially in an automatic dishwasher, the pouches herein have a square or rectangular base and a height of from about 1 to about 5 cm, more preferably from about 1 to about 4 cm. Preferably the weight of the solid composition is from about 5 to about 20 grams, more preferably from about 10 to about 18 grams and the weight of the liquid compositions is from about 0.5 to about 10 grams, more preferably from about 1 to about 8 grams.

The enveloping materials which form different compartments can have different solubility, under the same conditions, releasing the content of the compositions which they partially or totally envelope at different times.

Controlled release of the ingredients of a multi-compartment pouch can be achieved by modifying the thickness and/or the solubility of the enveloping material. The solubility of the enveloping material can be delayed by for example cross-linking the film as described in WO 02/102,955 at pages 17 and 18. Other enveloping materials, in particular water-soluble films designed for rinse release are described in U.S. Pat. No. 4,765,916 and U.S. Pat. No. 4,972,017. Waxy coating (see WO 95/29982) of films can help with rinse release. pH controlled release means are described in WO 04/111178, in particular amino-acetylated polysaccharide having selective degree of acetylation.

Other means of obtaining delayed release by multi-compartment pouches with different compartments, where the compartments are made of films having different solubility are taught in WO 02/08380.

### Example

Aqueous compositions comprising 40% of MGDA were prepared. Comparative Composition A is a liquid aqueous solution of only MGDA and has a high eRH (78%). Such a high eRH would be too high for the composition to be placed in a water-soluble pouch. Compositions B and C contain sodium formate, 5% and 10% respectively. Compositions B and C have lower eRH, 69.9% and 61.3%, respectively. This makes the compositions more adequate to be placed in a water-soluble pouch.

| Ingredients (parts | | | |
|---|---|---|---|
| by weight) | Composition A | Composition B | Composition C |
| MGDA | 40 | 40 | 40 |
| Na formate | | 5 | 10 |
| Water | 60 | 55 | 50 |
| eRH | 78% | 69.6 | 61.3 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A single or multi-compartment water-soluble cleaning pouch comprising a cleaning composition and an enveloping material, the pouch comprising at least one compartment comprising a liquid composition said liquid composition comprising a mixture of a complexing agent and an eRH reducing agent wherein the complexing agent is selected from the group consisting of methyl glycine diacetic acid, its salts and mixtures thereof and the eRH reducing agent is a salt of an organic acid selected from the group consisting of mono-, di-carboxylic acids and mixtures thereof.

2. A pouch according to claim 1 wherein the mixture of the complexing agent and the eRH reducing agent comprises at least about 10% by weight thereof of the complexing agent.

3. A pouch according to claim 1 wherein the liquid composition has an eRH of about 65% or less at about 20° C.

4. A pouch according to claim 1 wherein the liquid composition is an aqueous composition comprising about 10% or more of water by weight thereof.

5. A pouch according to claim 1 wherein the liquid composition comprises at least about 30% of the mixture by weight thereof.

6. A pouch according to claim 1 wherein the liquid composition comprises at least about 40% of the mixture by weight thereof.

7. A pouch according to claim 1 wherein the salt is an alkali salt of a mono-carboxylic acid selected from the group consisting of formic acid, acetic acid and mixtures thereof.

8. A pouch according to claim 1 wherein the salt comprises potassium as cation.

9. A pouch according to claim 1 wherein the weight ratio of the complexing agent to the eRH reducing agent is in the range of from about 2:1 to about 10:1.

10. A pouch according to claim 1 the liquid composition comprises a polyamine wherein the hydrogen atoms of the amines have been partially or fully substituted by —CH2COOH groups, partially or fully neutralized with alkali metal cations.

11. A pouch according to claim 1 wherein the liquid composition comprises a second complexing agent wherein the second complexing agent is an aminocarboxylate complexing agent selected from the group consisting of glutamic acid diacetic acid, its salts and mixtures thereof

12. A pouch according to claim 1 wherein the liquid composition has a pH of from about 10 to about 11 as measured as an about 1% aqueous solution at about 22° C.

13. A pouch according to claim 1 wherein the liquid composition has a dynamic viscosity of from about 300 to about 600 mPa s determined according to DIN 53018-1:2008-09 at about 23° C.

14. A pouch according to claim 1 wherein the liquid composition comprises:
from about 10 to about 50% by weight thereof of the complexing agent,
from about 10 to about 50% by weight thereof of the second complexing agent,
from about 5 to about 30% by weight thereof of a salt of formic acid, acetic acid or a mixture thereof,
from 0 to about 5% by weight thereof of a polyamine wherein the hydrogen atoms of the amines have been partially or fully substituted by —CH2COOH groups, partially or fully neutralized with alkali metal cations.

15. A pouch according to claim 1 wherein the enveloping material comprises polyvinyl alcohol and a plasticiser and the liquid composition preferably comprises a plasticiser.

16. A pouch according to claim 1 further comprising a second compartment containing a second composition comprising a moisture sensitive ingredient selected from the group consisting of bleach, enzymes and mixtures thereof.
